(19) United States
(12) Patent Application Publication
(10) Pub. No.: US 2008/0163128 A1
(43) Pub. Date: Jul. 3, 2008

(54) Click-Fraud Prevention

(76) Inventors: Sean Callanan, Dublin (IE); Patrick J. O'Sullivan, Dublin (IE); Edith H. Stern, Yorktown Heights, NY (US); Robert C. Weir, Westford, MA (US); Barry E. Willner, Briarcliff Manor, NY (US)

Correspondence Address: DILLON & YUDELL LLP, 8911 N. CAPITAL OF TEXAS HWY., SUITE 2110, AUSTIN, TX, 78759, US

(21) Appl. No.: 11/617,127

(22) Filed: Dec. 28, 2006

(51) Int. Cl. G06F 3/048

(52) U.S. Cl. 715/856

(57) ABSTRACT

A method, system and computer-readable medium for defeating clickbots are presented. In a preferred embodiment, the method includes, but is not limited to, the steps of: detecting a click on a Pay Per Click (PPC) link on a first webpage; in response to detecting the click on the PPC link, presenting a confirmation webpage, wherein the confirmation webpage comprises a confirmation button that is positioned at a random position on the confirmation webpage; and in response to detecting a click of the confirmation button, directing a user to a second webpage that is associated with the PPC link

### BACKGROUND OF THE INVENTION

The present invention relates in general to the field of computers and other data processing systems, including hardware, software and processes. More particularly, the present invention pertains to preventing fraudulent clicking of Pay Per Click (PPC) advertisements.

Pay Per Click (PPC) is a fundamental market of the Internet. In a PPC model, an Advertiser creates a clickable advertisement link from a popular public webpage that is maintained by a Publisher. Whenever a visitor to that webpage clicks the advertisement link, the Advertiser pays the Publisher of the popular public webpage a fee. That is, the Advertiser pays the Publisher for each “click through” which a visitor to the Publisher's webpage generates, thus paying the Publisher for each “referral” to the Advertiser's webpage.

Click Fraud (CF) occurs when a person or organization repeatedly generates clicks to a PPC advertisement with the intent of generating an improper charge to the Advertiser. Typically, this repeated clicking is automatically performed by a “clickbot,” which is software-based logic that emulates movement of a pointer over the PPC advertisement and clicking thereon. Parties who may have an economic motivation to commit CF include the Publisher, an Advertising Network whose revenues are based on how often their advertisements are clicked, an Advertisement Agency whose revenues and/or reputation are enhanced according to how often the ads they create are clicked (regardless of which Publisher webpage publishes the PPC link), and competitors of the Advertiser who wish to deplete the Advertiser's advertising budget.

Although CF is clearly unethical and is illegal in several jurisdictions, the practice nonetheless continues, and according to some estimates, accounts for 2-20% of all clicks of PPC advertisements.

### SUMMARY OF THE INVENTION

To address the problem of click fraud described above, the present invention presents a computer-implementable method, system and computer media for preventing click fraud. In a preferred embodiment, the method includes, but is not limited to, the steps of: detecting a click on a Pay Per Click (PPC) advertisement link on a Publisher's webpage; in response to detecting the click on the PPC advertisement link, presenting a confirmation webpage, wherein the confirmation webpage comprises a confirmation button that is positioned at a random position on the confirmation webpage; and in response to detecting a click of the confirmation button, directing a user to an advertiser's webpage that is associated with the PPC advertisement link.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1A depicts a publisher's webpage that contains an advertiser's Pay Per Click (PPC) advertisement link;

FIG. 1B illustrates a confirmation webpage that contains a bitmapped presentation of a confirmation request message, a single confirmation button, and hidden “TRAP” clickable areas for detecting fraudulent clickbot activity;

FIG. 1C depicts a repeat confirmation webpage for enabling connection to the advertiser's webpage;

FIG. 1D illustrates a warning webpage that gives notice that access to the advertiser's webpage has been denied;

FIG. 1E illustrates the advertiser's webpage;

FIG. 1F depicts a PPC link that directly includes a confirmation button and at least one “TRAP” clickable area;

FIG. 2A is a flow-chart of exemplary steps taken to afford access to the advertiser's webpage via the confirmation webpage;

FIG. 2B is a flow-chart of exemplary steps taken to generate stochastic data; and

FIG. 3 depicts an exemplary supervisory computer in which the present invention may be implemented.

### DETAILED DESCRIPTION OF THE PREFERRED EMBODIMENT

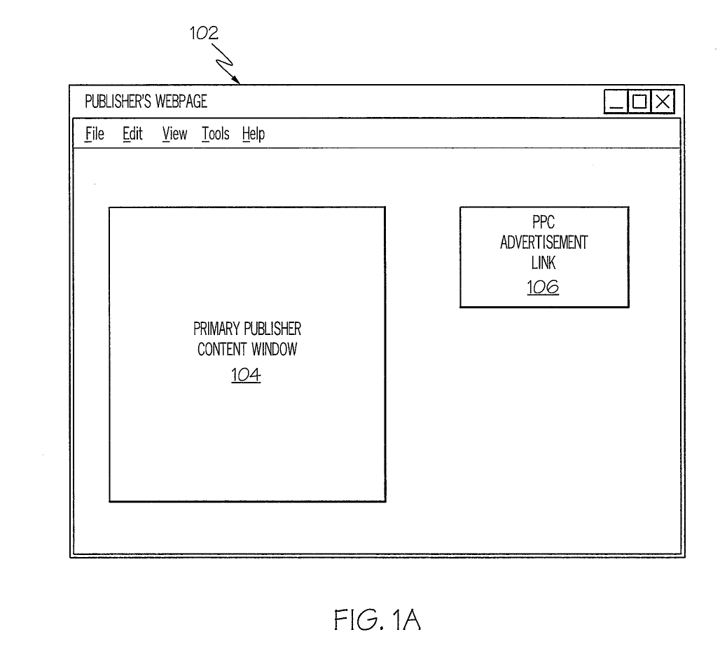

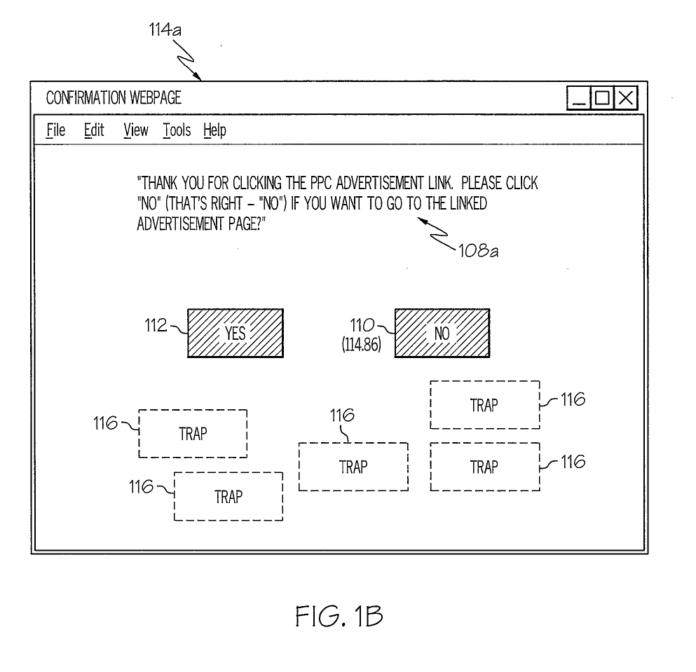

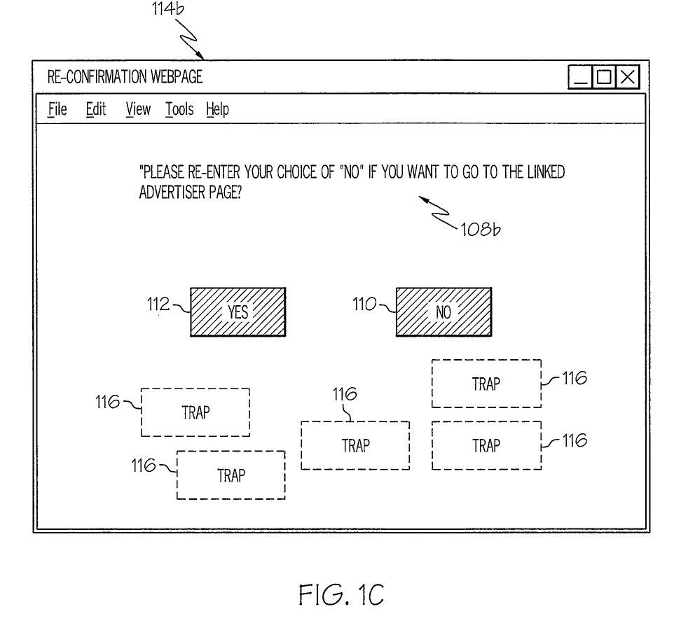

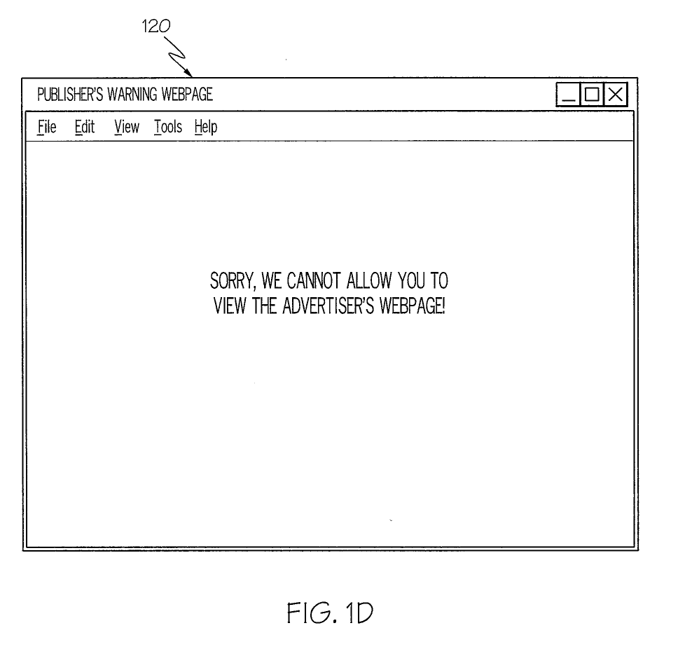

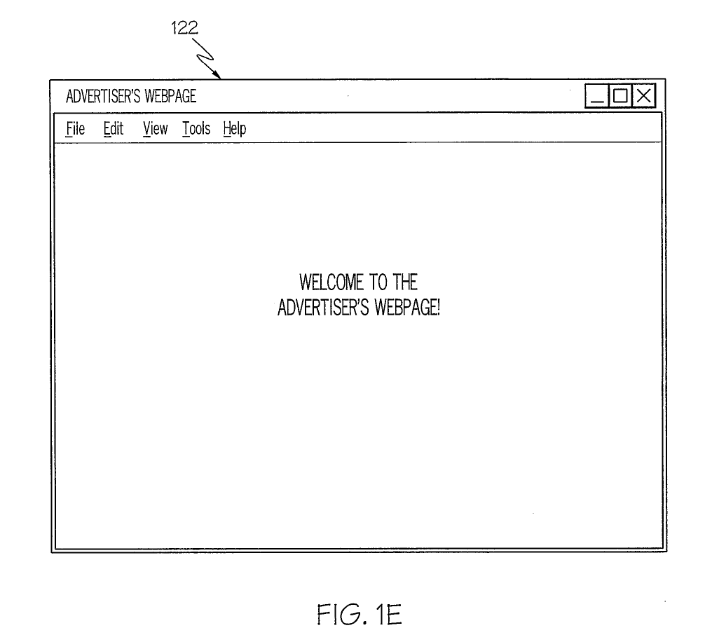

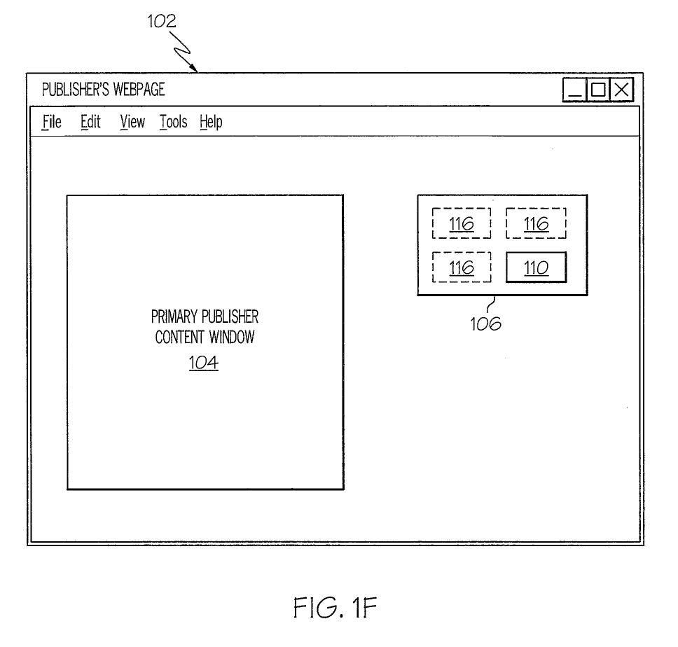

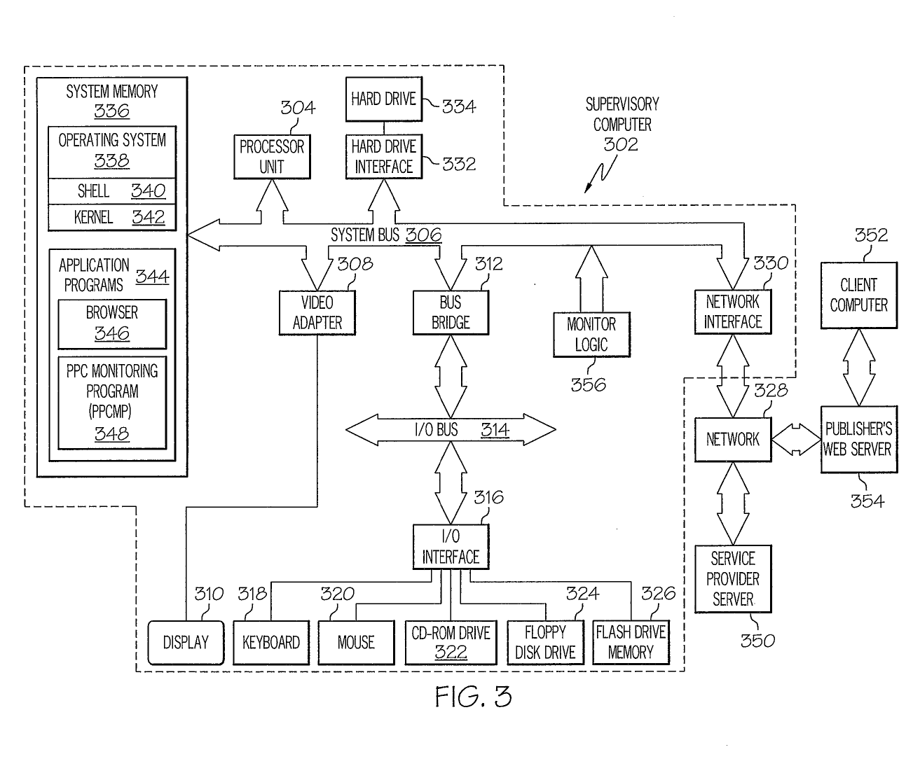

With reference now to the figures, and in particular to FIG. 1A, an exemplary publisher's webpage 102 is shown. The Graphical User Interface (GUI) that displays publisher's webpage 102 includes a primary publisher content window 104, which is the primary content of publisher's webpage 102. For example, primary publisher content window 104 may display content from a home page of a search engine, an enterprise's home page, a subscriber's content, etc. Publisher's webpage 102 also includes a Pay Per Click (PPC) advertisement link 106. PPC advertisement link 106 is an active link to an advertiser's webpage. Thus, by clicking the PPC advertisement link 106, a visitor to publisher's webpage 102 is redirected to the webpage of the advertiser. Each time a visitor clicks the PPC advertisement link 106, underlying logic generates a count, which is used to bill the advertiser for the on-line “referral.” Thus, each time PPC advertisement link 106 is clicked, that click action is reported to and recorded by a PPC monitoring program (PPCMP) 348 through the use of a monitor logic 356 (shown in FIG. 3). As described below, monitor logic 356 and PPCMP 348 also monitor and record clicks of incorrect and “TRAP” clickable areas on publisher's webpage 102, thus revealing probable clickbot activity. Note that, in a preferred embodiment, publisher's webpage 102 is published on the Internet by a Publisher's Web Server 354, but is supervised, in a manner described below, by a Supervisory computer 302 (also shown and described in FIG. 3).

Reference is now made to FIG. 1B, which depicts an exemplary confirmation webpage 114a. Confirmation webpage 114a is presented to a user who has previously clicked PPC advertisement link 106 (shown in FIG. 1A). In order to permit the advertiser's page (which is associated with the clicked PPC advertisement link 106) to be presented to the user, the user must click a confirmation button 110. Note that confirmation webpage 114a has several features that are designed to overcome clickbots and similar logic.

First, the confirmation instructions 108a are printed in an image format in which the original text cannot be easily retrieved, if at all, by a clickbot. That is, the instructions depicted in confirmation instructions 108a are bit-mapped lines that have no text character code embedded in the figures.

Second, the confirmation button 110 has a label that is counter-intuitive. That is, it would be intuitive for a user click a “YES” button 112 to go to the advertiser's webpage. To overcome this assumption, however, the confirmation button 110 is labeled “NO.” Alternatively, the label may be randomly presented, such that the confirmation button 110 will be labeled “YES” in some cases and “NO” in other cases, depending on the wording of the confirmation instructions 108a.

Third, the confirmation button 110 has a background that makes it difficult, if not impossible, for computer-based image recognition to identify the lettering within the confirmation button 110. Note that the lettering within the confirmation button 110 may also be scripted in a non-text character manner as described above for the confirmation instructions 108a.

Fourth, the location of the confirmation button 110 may be changed for a given presentation of the confirmation webpage 114a. That is, the location of confirmation button 110 may be varied periodically, or according to algorithms dependent on stochastic data, how many times the confirmation button 110 is clicked, or other data or information. Thus, the positioning of the confirmation button 110 on confirmation webpage 114a may vary during each presentation of confirmation webpage 114a. Note further that the location of confirmation button 110 may be static, or the confirmation button 110 may move in a predefined manner across confirmation webpage 114a. Via supervisory control provided by a supervisory computer (e.g., supervisory computer 302 shown in FIG. 3), a publisher's web server 354 (see FIG. 3) presents the confirmation button 110 in a different position when confirmation webpage 114a is presented. In one embodiment, this position is established by an output of a positioning algorithm that uses a unique input known only to the supervisory computer 302. For example, the supervisory computer 302 may input a current real-time value for the Dow Jones Industrial Average (DJIA) into the positioning algorithm. Since the real-time value for any moment in time can be later retrieved from historical records, then the supervisory computer 302 can later know where the valid confirmation button 110 is located on the real estate of the confirmation webpage 114a. For example, assume that the DJIA is 12,406.37 at exactly 2048.48.72 (Zulu time). Using the value “12,406.37” as in input to a positioning algorithm, then the supervisory computer 302 assigns the confirmation button 110 X,Y position coordinates such as “114,86”. Later, when the supervisory computer 302 receives a signal indicating that a clickable area in confirmation webpage 114a has been clicked, the supervisory computer 302 can determine, through the use of an historical table of past DJIA values, whether the click was of a confirmation button 110 or a non-confirmation clickable area. Note that, in a preferred embodiment, confirmation button 110 and non-confirmation clickable areas are merely pre-defined pixel areas on a User Interface (UI), and are not active HTML objects.

Fifth, there are multiple trap buttons 116 located throughout the User Interface (UI) of confirmation webpage 114a. Thus, if a clickbot simply clicks multiple areas of the real estate of the UI, then multiple “trap” click messages will be generated, indicating clickbot activity. These trap buttons 116 are preferably invisible to a user, but in an alternative embodiment, they are visible in the UI of the confirmation webpage 114a.

As shown in FIG. 1C, if a click of any clickable area, other than that for confirmation button 110, in confirmation webpage 114a is clicked, then a re-confirmation webpage 114b is presented, offering the user a second chance to click the proper confirmation button 110. Clicking any area other than confirmation button 110 will cause the presentation of a Publisher's Warning Webpage 120, shown in FIG. 1D, informing the user that she will not be directed to the advertiser's webpage. If the user DOES click the confirmation button 110 (either from confirmation webpage 114a or re-confirmation webpage 114b), then the Advertiser's Webpage 122 is presented, as shown in FIG. 1E.

Referring now to FIG. 1E, in another embodiment the PPC link 106 is directly populated with the confirmation button 110 as well as trap buttons 116 (which may also include a button 112 described above). Thus, if the user clicks the correct real estate covered by confirmation button 110, then the user will be directly taken to the associated webpage (e.g., Advertiser's Webpage 122). However, if the user (or clickbot) clicks any of the trap buttons 116, then (preferably) a second chance is given to the user via a confirmation webpage 114b. If the user (or clickbot) fails to click the correct confirmation area (button 110) in the confirmation webpage 114b, then access to the requested webpage is denied as described above. Note that in one embodiment, the confirmation button 110 may appear as a graphic design, such as a corporate logo, picture, etc., such that the PPC link 106 includes instructions to click an area described. That is, the PPC link 106 may include an instruction box telling a user to “Click the swan” is the confirmation button 110 included an image of a swan. This provides an additional level of protection from a clickbot, which would need additional logic to associate the wording “swan” with an image of a swan. Thus, if there were images of other birds in trap buttons 116, a clickbot would be unable to tell which image is a swan and which is another bird.

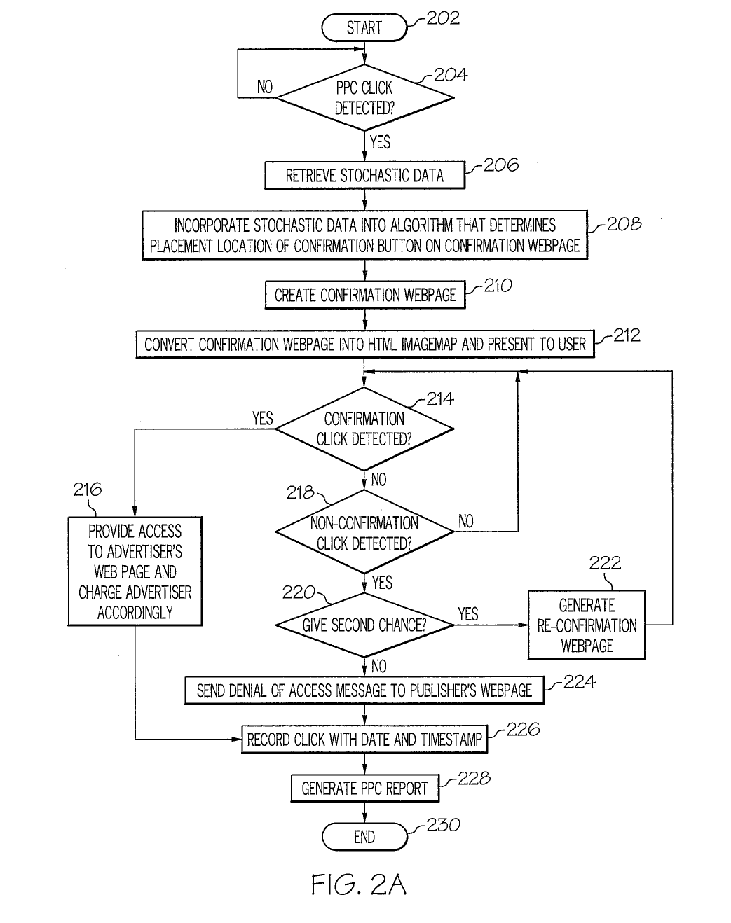

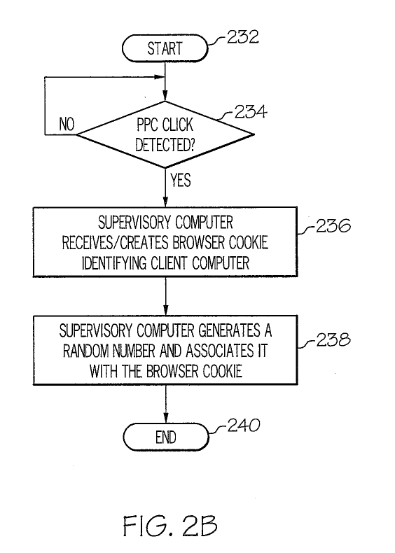

With reference now to FIG. 2A, a flow-chart of exemplary steps taken to overcome clickbots is presented. After initiator block 202, a PPC click is detected (query block 204). An exemplary PPC click is a clicking action on a PPC advertisement link 106, as shown in FIG. 1A. In response to a PPC click being detected, stochastic data is retrieved (block 206). Note that in a preferred embodiment, the PPC click is detected by a supervisory computer (e.g., supervisory computer 302 shown in FIG. 3) via a message sent from a web server (e.g., publisher's web server 354 also shown in FIG. 3) that is serving up the webpage that is populated with PPC advertisement link 106. Similarly, supervisory computer 302 preferably is used to retrieve the stochastic data. Alternatively, detecting the PPC click and retrieving the stochastic data may be performed directly by the publisher's web server 354, subject to security issues discussed below.

Stochastic data is defined as data that is not dependent on, or at least not easily predicted from, prior data or activity. Furthermore, for the purposes of the present disclosure, the term “stochastic” is further used to define and describe data that is determined at a specific time, wherein that data is used as an input to an algorithm that defines X,Y coordinates for placement of a confirmation button on a confirmation webpage. Examples of such stochastic data include real-time stock quotes, a stock market average such as the Dow Jones Industrial Average (DJIA), the Nikkei stock market, etc. However, in a preferred embodiment that avoids problems associated with stock delays, timing and clock differences, etc., the stochastic data is generated using browser cookies and a random number generator. For example, consider the flow-chart shown in FIG. 2B. After initiator block 232, a query is made as to whether the supervisory computer has detected a PPC click (query block 234). If so, then the supervisory computer receives from the client computer (from which the PPC click was generated) a browser cookie that identifies the client computer and/or the user who clicked the PPC button (block 236). If the client computer does not send a browser cookie, then the supervisory computer can generate and assign one for the client computer. The supervisory computer then generates a random number, and associates that random number with the value of the browser cookie (block 238). An exemplary manner in which the supervisory computer can associate the random number is to store the random number in a database that is keyed by the value of the cookie, thus making it available for later reference via the value of the cookie. The process then ends at terminator block 240, at which point the process returns to block 208 of FIG. 1A.

As described in block 208 of FIG. 1a, the calculated X,Y coordinates are then used to place the confirmation button in a specific location on the User Interface (UI) of the confirmation webpage. The confirmation webpage is then created (block 210) preferably utilizing the components described above in FIG. 1B. That is, in a preferred embodiment, the confirmation webpage includes image character representations of text (i.e., “image character representations” are defined as line drawings that are not created by stored code, such as ASCII character code, etc., that defines text characters, but rather are purely visual representations, created by a non-text graphical application, that “look” like text characters to a human viewer, but are not decipherable as text by a computer) in messages and buttons; non-intuitive confirmation buttons for confirming a human user's desire to view the advertiser's webpage; confirmation buttons that are stochastically positioned; and/or hidden “TRAP” clickable regions.

In order to further hide information that could be used by a clickbot to automatically click a confirmation button, the confirmation webpage is the converted into an HTML imagemap image (e.g., using pseudocode shown above), which has clickable areas (block 212). Preferably, this step of converting the confirmation webpage into a bitmap image is performed by a supervisory computer (e.g., supervisory computer 302 shown in FIG. 3 below). By having the supervisory computer 302 convert the webpage into a bitmap image, then when the confirmation webpage (e.g., conformation webpages 114a-b depicted above) is presented by a publisher's web server (354), a clickbot is unable to “see” code that identifies where the “real” confirmation button 110 is positioned. That is, converting the webpage into a bitmap image merges the collection of controls that would be in the original page into a single bitmap. This image (confirmation page) is thus presented to the user in an imagemap (which has the structure of a bitmap). An imagemap is an image presented to the user, in the browser, that will respond differently depending on the area of the image the user click. The following is an example of an imagemap represented in HyperText Markup Language (HTML) pseudocode:

<MAP NAME=“Confirmation”>
<IMG USEMAP=“Confirm request”
SRC=“confirmationServlet?image=Confirmation01020e0f0 lccl .J PG”
BORDER=0>
<AREA SHAPE=“Rect” HREF=“confirmationServlet?x=0&y=0&cx=1&
cy=1” COORDS=“0,0, 1,1 ”>
<AREA SHAPE=“Rect” HREF=“confirmationServlet?x=1&y=1&cx=2
&cy=2” COORDS=“1,1, 2,2”>
<AREA SHAPE=“Rect” HREF=“confirmationServlet?x=2&y=2&cx=3&
cy=3” COORDS=“2,2, 3,3”>
<AREA SHAPE=“Rect” HREF=“confirmationServlet?x=3&y=3&cx=4&
cy=4” COORDS=“3,3, 4,4”>
<AREA SHAPE=“Rect” HREF=“confirmationServlet?x=4&y=4&cx=5&
cy=5” COORDS=“4,4, 5,5”>
<AREA SRAPE=“Rect” HREF=“confirmationServlet?x=5&y=5&cx=6&
cy=6” COORDS=“5,5, 6,6”>
</MAP>

“Confirmation01020e0f01ccl.JPG” is a randomized name for the confirmation image that will be presented to the user. The image will have been previously created dynamically.

“AREA SHAPE” components represent the areas on the images that will respond to user clicks.

As described above, the UI of the confirmation webpage is covered with clickable “TRAP” areas. Clicking of a “NO” or “YES” area are preferably determined as being legitimate clicks (although they may be erroneous). However, clicks of “TRAP” areas are preferably assumed (determined) to be fraudulent, such as the result of action by a clickbot. In a preferred embodiment, a backend process such as a servlet returns an image with a random name, associates the images with the user session and remembers the coordinates of the positive and negative AREA SHAPE, for later validation.

Thus, all clickable areas in the confirmation webpage are non-descriptive in the HTML imagemap. That is, even if a clickbot were able to capture the imagemap code, the significance of each clickable area is hidden from the clickbot since the different “AREA SHAPEs” have functionality that is only known to a secure supervisor, such as supervisory computer 302 shown in FIG. 3. Alternatively, the publisher's web server 354 may “know” what the clickable areas are for, but there is still a firewall, encryption, or other security that prevents the use of the clickable areas from being discernable from the HTML code that creates the confirmation webpage.

Once the confirmation webpage is presented to the user, a confirmation click may be detected (query block 214). If the confirmation click is on the appropriate confirmation button, then the user is afforded access to the advertiser's web page (block 216), and the advertiser is charged for the “click through” to the advertiser's webpage. However, (query block 218) if the user clicks the wrong clickable area (either the incorrect visible button or an invisible “TRAP” clickable area), then the user is given a second chance (query block 220) by being presented (block 222) with a re-confirmation webpage (such as shown in exemplary form in FIG. 1C). (Note that in an alternative embodiment, the images and functionality of the publisher's webpage 102 and the confirmation webpage 114a, as depicted in respective FIG. 1A and FIG. 1B, may be on a same webpage, such that a user is prompted to click and confirm a PPC advertisement link from the same webpage.) If the second chance results in the same lack of a proper clicking of the confirmation button, then the user is presented with a message informing him that he is being denied access to the advertiser's webpage (block 224).

As described in block 226, a record of the incorrect clicks, time of date, URL or other identifier of the erroneously clicking entity (if available), and other collected data regarding the proper or improper PPC advertisement links is recorded. From this information, a report can be generated (block 228), allowing a manager of the PPC advertisement link to identify from where a clickbot attack is being originated, what time of day the clickbot attack is occurring, etc. The process ends at terminator block 230.

With reference now to FIG. 3, there is depicted a block diagram of an exemplary supervisory computer 302, in which the present invention may be utilized. In a preferred embodiment, management and supervision of the PPC advertisement link described above is performed by a different computer than the computer that places the PPC advertisement link on the web. That is, the publisher's webpage is preferably published by a different web server than a supervisory computer that performs the steps described above for defeating a clickbot. Alternatively, however, if the publisher's web server has logic that prevents a clickbot from viewing the underlying code used to create the publisher's webpage, then the steps described above may be performed directly by the publisher's web server.

Supervisory computer 302 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk-Read Only Memory (CD-ROM) drive 322, a floppy disk drive 324, and a flash drive memory 326. The format of the ports connected to I/O interface 316 may be any known to those skilled in the art of computer architecture, including but not limited to Universal Serial Bus (USB) ports.

Supervisory computer 302 is able to communicate with a service provider server 350 via a network 328 using a network interface 330, which is coupled to system bus 306. A primary function of service provider server 350 is to provide software to supervisory computer 302, preferably in an “on demand” manner. Alternatively, service provider server 350 can perform the functionality described herein for supervisory computer 302 and/or publisher's web server 354. That is, service provider server 350 may perform all of the functions associated with the present invention (including execution of PPCMP 348), thus freeing supervisory computer 302 and/or publisher's web server 354 from using their resources.

Network 328 may be an external network such as the Internet, or an internal network such as an Ethernet or a Virtual Private Network (VPN). Using network 328, supervisory computer 302 is able to use the present invention to access service provider server 350.

A hard drive interface 332 is also coupled to system bus 306. Hard drive interface 332 interfaces with a hard drive 334. In a preferred embodiment, hard drive 334 populates a system memory 336, which is also coupled to system bus 306. System memory is defined as a lowest level of volatile memory in supervisory computer 302. This volatile memory may include additional higher levels of volatile memory (not shown), including but not limited to cache memory, registers, and buffers. Data that populates system memory 336 includes supervisory computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., supervisory computer 302) to send and receive network messages to the Internet using HyperText Transfer Protocol (HTTP) messaging, thus enabling communication with service provider server 350.

Application programs 344 in supervisory computer 302's system memory also include a Pay Per Click Monitoring Program (PPCMP) 348, which receives PPC monitor data from monitor logic 356, and includes code for implementing the processes described in FIGS. 1a-e and 2a-b. Note that the functionality of monitor logic 356 may be implemented in software or hardware. Additionally, the functionality of monitor logic 356 may be included as an integrated function of the software in PPCMP 348. In one embodiment, supervisory computer 302 is able to download PPCMP 348 from service provider server 350, preferably in an “on demand” basis.

Also coupled to supervisory computer 302, via network 328, is a browser-based client computer 352, which is used by a person who is legitimately (or illegitimately) clicking the PPC advertisement link described above. Note that the hardware architecture described for supervisory computer 302 may be substantially similar for service provider server 350, browser-based client 352 and publisher's web server 354.

The hardware elements depicted in supervisory computer 302 are not intended to be exhaustive, but rather are representative to highlight essential components required by the present invention. For instance, supervisory computer 302 may include alternate memory storage devices such as magnetic cassettes, Digital Versatile Disks (DVDs), Bernoulli cartridges, and the like. These and other variations are intended to be within the spirit and scope of the present invention.

It should be understood that at least some aspects of the present invention may alternatively be implemented in a computer-useable medium that contains a program product. Programs defining functions of the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of PPCMP 348 (as well as the function of monitor logic 356), are performed by service provider server 350. Alternatively, PPCMP 348 (and, if implemented in software, monitor logic 356) can be deployed as a process software from service provider server 350 to supervisory computer 302. This deployment may be performed in an “on demand” basis manner, in which PPCMP 348 (and/or monitor logic 356) is only deployed when needed by supervisory computer 302. In another embodiment, process software for the method so described may be deployed to service provider server 350 by another service provider server (not shown).

The present disclosure thus presents a method, system, and computer-readable medium for preventing click fraud. In a preferred embodiment, the method includes the steps of: detecting a click on a Pay Per Click (PPC) link on a first webpage; in response to detecting the click on the PPC link, presenting a confirmation webpage, wherein the confirmation webpage comprises a confirmation button that is positioned at a variable position on the confirmation webpage; and in response to detecting a click of the confirmation button, directing a user to an advertiser's webpage that is associated with the PPC link. The method may also include the step of populating the confirmation webpage with user instructions for clicking the confirmation button using image character representations that are designed to be indecipherable by a computer logic. In another embodiment, the method includes the step of populating the confirmation webpage with trap clickable areas that are invisible, or in an alternate embodiment are visible, to a user, wherein a click of a trap clickable area generates a notification message of invalid clicking.

In one embodiment, the confirmation button includes non-intuitive instructions that are the opposite of expected language for confirming a user's desire to view an advertiser's webpage that is associated with the PPC link. This non-intuitive language can be presented with image character representations, wherein the image character representations are designed to be indecipherable by a computer logic.

In another embodiment, the method includes the additional steps of: generating an imagemap of the confirmation webpage; presenting the imagemap to a user, wherein the imagemap is devoid of information that is usable by a clickbot to determine which viewable area within the imagemap is dedicated to the confirmation button.

In another embodiment, the method includes the additional step of, in response to a click being detected on the confirmation webpage in an area other than the confirmation button, presenting a reconfirmation webpage to a user, wherein the re-confirmation webpage includes another confirmation button.

In another embodiment, the confirmation webpage is presented by a first web server, and wherein the confirmation webpage is generated by a supervisory computer whose logic for generating the confirmation webpage is hidden from the first web server.

In another embodiment, the method further comprises generating a PPC report, wherein the PPC report includes at least one identifier of at least one user who fails to correctly click the confirmation button, a count of fraudulent clicks of the PPC advertisement link, and a time description of when the fraudulent clicks of the PPC advertisement link occurred.

In another embodiment, the method comprises the steps of: detecting a click on a confirmation button that is embedded in a Pay Per Click (PPC) link on a first webpage; in response to detecting the click on the confirmation button, presenting a second webpage that is associated with the PPC link; and in response to detecting a click of a trap button that is embedded in the PPC link, denying access to the second webpage. In this embodiment, the method may further include the steps of: in response to detecting the click on the trap button, presenting a third webpage that offers a second chance to click an other conformation button; in response to the other confirmation button being clicked, presenting the second webpage; and in response to an other trap button in the third webpage being clicked, denying access to the second webpage.

In another embodiment, the method comprises the steps of: presenting a Pay Per Click (PPC) link representation on a first webpage and a second webpage, wherein a viewable area, within each PPC link representation, is dedicated to a confirmation button that, when clicked, authorizes a third webpage to be presented to a user, and wherein the viewable area that is dedicated to the confirmation button is positioned differently on the PPC link representations in the first and second webpages, and wherein the PPC link representation is designed to be devoid of information that is readable by a clickbot for distinguishing functionality of different viewable areas of the PPC link; and in response to detecting a click of the confirmation button, presenting the third webpage. This method may further include the step of, in response to detecting a click of a trap button that is embedded in the PPC link, denying access to the third webpage.

Some or all of the method steps described above may be implemented in a computer system, and may further be executed by instructions that are stored in a computer readable medium.

In another embodiment, in which the method described herein is performed by software that is stored on a computer-readable medium, the computer-usable medium is a component of a remote server, and the computer executable instructions are deployable to a supervisory computer from the remote server. This deployment may be provided by a service provider to a customer on an on-demand basis.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

Furthermore, while the present invention has been described in an exemplary manner in which certain functions have been performed by certain servers, it is understood that steps described may be performed by other servers. For example, the steps of detecting a click of a PPC advertisement link, presenting a confirmation webpage, directing a user to an advertiser's webpage, et al., may be performed by either the supervisory computer 302, the publisher's web server 354, or the service provider server 350 shown in FIG. 3. Alternatively, the steps described herein (including but not limited to those detailed in FIGS. 2a-b) may be performed by any combination of supervisory computer 302, publisher's web server 354, and/or service provider server 350. Similarly, while links, buttons, windows, etc. have been depicted for exemplary purposes as populating a “Publisher's Webpage” or a “Confirmation Webpage” or a “Warning Webpage” or an “Advertiser's Webpage,” such links, buttons, windows, etc. may be displayed on a different or same webpage as that depicted. Finally, while the PPC link depicted and described here has been portrayed as an advertisement link, it is within the scope of the present disclosure and appended claims that any type of PPC link is to be understood as being within the scope of the presently disclosed method, system, and/or computer program product.

Note further that steps described and claimed herein, such as detecting a click on a Pay Per Click (PPC) link, presenting a confirmation webpage, directing a user to a second webpage that is associated with the PPC link, et al., may be directly performed by a particular server, or may indirectly performed as a result of a message received that one or more step in a process has occurred at another server. For example, publisher's web server 354 may detect that a PPC link has been clicked, supervisory computer 302 may present the confirmation webpage, and service provider server 350 may direct the user to the second webpage. Alternatively, any described server may perform any of the steps described and claimed herein through the use of appropriate communication among the servers.

What is claimed is:

1. A computer-implementable method of preventing click fraud, the computer-implementable method comprising:
detecting a click on a Pay Per Click (PPC) link on a first webpage;
in response to detecting the click on the PPC link, presenting a confirmation webpage, wherein the confirmation webpage comprises a confirmation button that is positioned at a variable position on the confirmation webpage; and
in response to detecting a click of the confirmation button, directing a user to a second webpage that is associated with the PPC link.

2. The computer-implementable method of claim 1, further comprising:
populating the confirmation webpage with user instructions for clicking the confirmation button, wherein the user instructions are presented on the confirmation webpage using image character representations, wherein the image character representations are designed to be indecipherable by a computer logic.

3. The computer-implementable method of claim 1, further comprising:
populating the confirmation webpage with trap clickable areas that are invisible to a user, wherein a click of a trap clickable area generates notification message of invalid clicking.

4. The computer-implementable method of claim 1, wherein the confirmation button includes non-intuitive instructions for confirming a user's desire to view a webpage that is associated with the PPC link.

5. The computer-implemented method of claim 4, wherein the non-intuitive language is presented with image character representations, wherein the image character representations are designed to be indecipherable by a computer logic.

6. The computer-implemented method of claim 1, further comprising:
generating an imagemap of the confirmation webpage; and
presenting the imagemap to a user, wherein the imagemap is devoid of information that is usable by a clickbot to determine which viewable area within the imagemap is dedicated to the confirmation button.

7. The computer-implemented method of claim 1, further comprising:
in response to a click being detected on the confirmation webpage in an area other than the confirmation button, presenting a reconfirmation webpage to a user, wherein the re-confirmation webpage includes another confirmation button.

8. The method of claim 1, wherein the confirmation webpage is presented by a first web server, and wherein the confirmation webpage is generated by a supervisory computer whose logic for generating the confirmation webpage is hidden from the first web server.

9. The method of claim 1, further comprising:
generating a PPC report, wherein the PPC report includes at least one identifier of at least one user who fails to correctly click the confirmation button, a count of fraudulent clicks of the PPC link, and a time description of when the fraudulent clicks of the PPC link occurred.

10. The computer-implementable method of claim 1, further comprising:
populating the confirmation webpage with trap clickable areas that are visible to a user, wherein a click of a trap clickable area generates a warning message of fraudulent PPC link clicking.

11. A system comprising:
a processor;
a data bus coupled to the processor;
a memory coupled to the data bus; and
a computer-usable medium embodying computer program code, the computer program code comprising instructions executable by the processor and configured for preventing click fraud by performing the steps of:
detecting a click on a Pay Per Click (PPC) advertisement link on a First webpage;
in response to detecting the click on the PPC link, presenting a confirmation webpage, wherein the confirmation webpage comprises a confirmation button that is positioned at a variable position on the confirmation webpage; and
in response to detecting a click of the confirmation button, directing a user to a second webpage that is associated with the PPC link.

12. The system of claim 11, wherein the instructions are further configured for:
populating the confirmation webpage with user instructions for clicking the confirmation button, wherein the user instructions are presented on the confirmation webpage using image character representations, wherein the image character representations are designed to be indecipherable by a computer logic.

13. The system of claim 11, wherein the instructions are further configured for:
populating the confirmation webpage with trap clickable areas that are invisible to a user, wherein a click of a trap clickable area generates a notification message of improper clicking.

14. The system of claim 11, wherein the instructions are further configured for:
generating an imagemap of the confirmation webpage; and
presenting the imagemap to a user, wherein the imagemap is devoid of information that is usable by a clickbot to determine which viewable area within the imagemap is dedicated to the confirmation button.

15. The system of claim 11, wherein the instructions are further configured for:
in response to a click being detected on the confirmation webpage in an area other than the confirmation button, presenting a re-confirmation webpage to a user, wherein the re-confirmation webpage includes another confirmation button.

16. A computer-readable medium encoded with a computer program, the computer program comprising computer executable instructions configured for:
detecting a click on a Pay Per Click (PPC) link on a first webpage;
in response to detecting the click on the PPC link, presenting a confirmation webpage, wherein the confirmation webpage comprises a confirmation button that is positioned at a variable position on the confirmation webpage; and
in response to detecting a click of the confirmation button, directing a user to a second webpage that is associated with the PPC link.

17. The computer-readable medium of claim 16, wherein the instructions are further configured for:
populating the confirmation webpage with user instructions for clicking the confirmation button, wherein the user instructions are presented on the confirmation webpage using image character representations, wherein the image character representations are designed to be indecipherable by a computer logic.

18. The computer-readable medium of claim 16, wherein the instructions are further configured for:
populating the confirmation webpage with trap clickable areas that are invisible to a user, wherein a click of a trap clickable area generates a notification message of invalid clicking.

19. The computer-readable medium of claim 16, wherein the computer-usable medium is a component of a remote server, and wherein the computer executable instructions are deployable to a supervisory computer from the remote server.

20. The computer-readable medium of claim 16, wherein the computer executable instructions are capable of being provided by a service provider to a customer on an on-demand basis.

21. A computer-implementable method of preventing click fraud, the computer-implementable method comprising:
detecting a click on a confirmation button that is embedded in a Pay Per Click (PPC) link on a first webpage;
in response to detecting the click on the confirmation button, presenting a second webpage that is associated with the PPC link; and
in response to detecting a click of a trap button that is embedded in the PPC link, denying access to the second webpage.

22. The computer-implementable method of claim 21, further comprising:
in response to detecting the click on the trap button, presenting a third webpage that offers a second chance to click an other conformation button;
in response to the other confirmation button being clicked, presenting the second webpage; and
in response to an other trap button in the third webpage being clicked, denying access to the second webpage.

23. A computer-implementable method of preventing click fraud, the computer-implementable method comprising:
presenting a Pay Per Click (PPC) link representation on a first webpage and a second webpage,
wherein a viewable area, within each PPC link representation, is dedicated to a confirmation button that, when clicked, authorizes a third webpage to be presented to a user, and
wherein the viewable area that is dedicated to the confirmation button is positioned differently on the PPC link representations in the first and second webpages, and
wherein the PPC link representation is designed to be devoid of information that is readable by a clickbot for distinguishing functionality of different viewable areas of the PPC link; and
in response to detecting a click of the confirmation button, presenting the third webpage.

24. The computer-implementable method of claim 23, further comprising:
in response to detecting a click of a trap button that is embedded in the PPC link, denying access to the third webpage.
